(19) United States
(12) Patent Application Publication
(10) Pub. No.: US 2026/0145506 A1
(43) Pub. Date: May 28, 2026

(54) TRANSMISSION ASSEMBLY FOR A HYBRID DRIVE

(71) Applicant: GKN Automotive Limited, Birmingham (GB)

(72) Inventors: Mark Schmidt, Lohmar (DE); Thomas Schepanowski, Lohmar (DE)

(21) Appl. No.: 19/398,783

(22) Filed: Nov. 24, 2025

(30) Foreign Application Priority Data
Nov. 27, 2024 (DE) 102024135036.9

(51) Int. Cl. B60K 6/547; B60K 6/36; B60K 6/387; B60K 6/48

(52) U.S. Cl. CPC B60K 6/547; B60K 6/36; B60K 6/387; B60K 6/48; B60K 2006/4808; B60K 2006/4841

(57) ABSTRACT

A transmission assembly comprising: a transmission housing, a multi-stage transmission that can be drivingly connected to an internal combustion engine, a reduction gearing that can be drivingly connected to an electric motor, a differential gearing with a differential input gear that meshes with a transmission output gear and a reduction gearing output gear, wherein the transmission output gear is arranged axially outside a space formed between a first gear plane and a second gear plane of the multi-stage transmission. The disclosure also relates to a hybrid assembly with such a transmission assembly.

### CROSS REFERENCE TO RELATED APPLICATIONS

This application claims priority to German Patent Application No. DE102024135036.9 filed on Nov. 27, 2024, and the entire content of this priority application is incorporated herein by reference in its entirety.

### TECHNICAL FIELD

The disclosure relates to a transmission assembly for a hybrid drive for a motor vehicle and a hybrid drive with such a transmission assembly.

### BACKGROUND

WO 2017/217064 A1, corresponding to EP 3 453 549A 1, discloses a transaxle device for a hybrid vehicle comprising an engine, a first electric machine, and a second electric machine. The transaxle device transmits power of the engine and power of the first electric machine individually to an output shaft, and also transmits power of the engine to the second rotating electric machine. Furthermore, the transaxle device comprises an input shaft connected coaxially to an engine shaft and a shift mechanism arranged on the input shaft and capable of being shifted to a high or low gear.

EP 3 988 363 A1, corresponding to US 11 807 100 B2 or JP 2021 054289 A, a vehicle drive transmission is known which comprises a first drive element coupled to an electric machine, a second drive element drivingly coupled to an internal combustion engine, and a differential unit for distributing the rotational movement from a differential input gear to two output elements.

WO 2021/093930 A1 discloses a transmission assembly for a hybrid drive comprising a multi-stage transmission connectable to the internal combustion engine with a first and second shift stage, a reduction gearing connectable to the electric machine, a superimposition gearing that can superimpose a rotational movement initiated by the multi-stage transmission on a rotational movement initiated by the reduction gearing and transmit it to a differential unit. The transmission assembly is also referred to as a multi-speed dedicated hybrid transmission (DHT). A multi-mode hybrid transmission (multi-mode DHT) is known from WO 2021/052557 A1, and a single-speed hybrid transmission (single-speed DHT) is known from WO 2021/089166 A1.

DE 10 2016 212 605 A1, DE 10 2019 130 884 A1, DE 10 2019 209 744 A1, and DE 10 2018 104 412 A1 disclose further hybrid transmissions for vehicles.

An object of at least some implementations of the present disclosure is to propose a transmission assembly for a hybrid drive with an internal combustion engine and an electric motor that has a compact design. Furthermore, a hybrid drive assembly with such a transmission assembly is proposed.

### SUMMARY

A solution proposed is a transmission assembly for a hybrid drive with an internal combustion engine and an electric motor, the transmission assembly comprising: a transmission housing; a multi-stage transmission with an input shaft that is mounted in the transmission housing to be rotatable about an input shaft axis and that is drivingly connectable to the internal combustion engine, a first pair of gears forming a first gear plane, and a second pair of gears forming a second gear plane, and a controllable shift clutch designed to selectively transmit rotational movement from the input shaft via the first pair of gears or the second pair of gears to a transmission output gear, or to interrupt transmission of the rotational movement; a reduction gearing with an input shaft that is drivingly connectable to the electric machine and designed to translate an introduced rotational movement to an output gear to slow speed; wherein a controllable clutch is provided in the power path of the reduction gearing to selectively transmit or interrupt the rotational movement; a differential gearing with a differential input gear that engages with the output gear of the multi-stage transmission and the output gear of the reduction gearing, and with a first differential output part for driving a first side shaft and a second differential output part for driving a second side shaft; wherein the output gear of the multi-stage transmission is arranged axially outside a space formed between the first gear plane and the second gear plane.

An advantage of the transmission assembly is that it has a compact design, particularly in the axial direction. Because the transmission output gear is arranged axially outside the space formed between the first and second gear planes, it is possible to arrange the input gear of the differential gearing in a space-saving manner relative to the multi-stage transmission, respectively the reduction gearing. This results in a particularly short axial size of the transmission assembly.

A particularly simple and compact design can be achieved if only a single power path is provided from each of the reduction gearing and the multi-stage transmission to the differential gearing. The two power paths are functionally parallel and can transmit rotational movements to the differential independently of each other. The multi-stage transmission can be designed with exactly two shift stages and only one output gear that meshes with the differential input gear. A rotational movement from the combustion engine can be transmitted to the differential with either a first or second transmission ratio. The reduction gearing is preferably designed with only one gear stage, i.e., it is not shiftable. A rotational movement initiated by the electric motor is transmitted to the differential with a fixed transmission ratio.

The transmission assembly may have an intermediate shaft parallel to the input shaft of the reduction gearing, with the shafts drivingly connected to each other via a set of spur gears to transmit rotational movement. Preferably, the controllable clutch is designed as a positive-locking clutch and is arranged coaxially with the intermediate shaft, axially between one of the spur gears and the output gear of the reduction gearing. A positive-locking clutch is understood to be a switchable clutch, such as a dog clutch, which can selectively establish a rotationally fixed connection through positive engagement of two or more clutch parts. The design as a positive-locking clutch and the arrangement between the spur gear plane and the output gear contribute to a particularly compact axial design of the reduction gearing. Further specifically, the positive-locking clutch may comprise a first clutch part firmly connected to one of the spur gears, and a second clutch part firmly connected to the intermediate shaft, and a coupling element for selectively connecting or disconnecting the first and second clutch parts to or from each other. The first and/or second clutch part can be connected to the respective rotary components integrally, i.e. in a one-piece manner. The spur gear set of the reduction gearing is preferably arranged axially offset from the first and second pairs of gears of the multi-stage transmission.

According to an embodiment, the first pair of gears may comprise a first gear rotatably mounted on the input shaft, and a first intermediate gear arranged on an intermediate shaft parallel to the input shaft. Furthermore, the second pair of gears may comprise a second gear rotatably mounted on the input shaft, and a second intermediate gear arranged on the intermediate shaft. An axial distance between the first and second intermediate gears may be smaller than an axial length of the teeth of the output gear of the multi-stage transmission, in particular smaller than 0.8 times the axial length of the output gear teeth. The two intermediate gears of the multi-stage transmission can therefore be arranged relatively close to each other, which contributes to an axially short design.

The multi-stage transmission can be designed in particular such that the first drive gear is smaller than the second drive gear, and the first intermediate gear is larger than the second intermediate gear. The transmission output gear can be arranged axially adjacent to the first intermediate gear, in particular axially between the first intermediate gear and a bearing of the intermediate shaft. At least one of the first and second intermediate gears, preferably both, are connected to the intermediate shaft solely by means of a press fit. This can reduce costs and improve NVH behavior through improved runout.

Further specifically, the output gear of the multi-stage transmission may be arranged on the side of the transmission assembly to be connected with the combustion engine, in particular axially between the first gear plane and a housing side wall through which the transmission input shaft extends for connecting the combustion engine. Accordingly, the differential input gear meshing with the transmission output gear may also be arranged axially adjacent to the pair of intermediate gears. The differential cage may have a flange section, wherein the differential input gear may be arranged at the side of the flange section facing the engine sided housing wall. These features may contribute individually or collectively to a space-saving arrangement of the differential in relation to the multi-stage transmission.

The transmission assembly may optionally comprise a generator shaft which may be arranged parallel to the transmission input shaft and drivingly connected thereto via a generator spur gear set. A generator connected to the transmission housing can convert the drive power supplied by the combustion engine into electrical energy, which can then be stored in a battery and used later for electric drive. A connecting region for the generator can be provided on the axially opposite side of the transmission housing, to which the combustion engine is connectable. In this case, the generator input shaft may extend out of the transmission housing on the opposite wall to the internal combustion engine. The set of spur gears of the generator driveline may have at least partial axial overlap with the transmission output gear. The spur gears can be arranged on the side of the transmission housing to which the internal combustion engine is to be connected, in particular axially between the first gear plane and the housing side wall of the internal combustion engine side and/or approximately in a plane with the toothing portion of the differential input gear. These features can also contribute to an axially compact design.

The transmission assembly may comprise a parking lock unit to lock the driveline in park mode and prevent unwanted rolling of the vehicle. The parking lock unit may comprise a lock wheel that is connected to a rotatable component of the transmission assembly in a rotationally fixed manner, and a locking element that is designed to engage with the lock wheel to selectively lock or release it. When in the closed position, the parking lock blocks rotational movement of the differential, respectively the side shafts connected thereto. For this purpose, the component connected to the lock wheel is preferably in direct drive connection with the differential input gear, i.e., without an intermediate clutch or the like. The lock wheel is preferably arranged axially between a plane spanned by the differential input gear and a side of the housing to which the electric machine can be connected. This is the side opposite to the one on which the combustion engine is located.

The parking lock unit can be arranged in the transmission assembly, depending on the installation space. According to a first possibility, the parking lock unit can be arranged in the power path of the electric machine, in particular between the clutch and the differential. For example, the parking lock unit can be provided on an intermediate shaft of the reduction gearing in direct drive connection with the differential. For an axially compact design, it is advantageous if the parking lock unit is arranged axially between a housing wall associated with the electric motor and the output gear of the reduction gearing. According to a second possibility, the parking lock unit can be arranged in the power path of the internal combustion engine, in particular between the shift clutch and the differential. For example, the parking lock wheel can be arranged on the intermediate shaft of the multi-stage transmission in direct drive connection with the differential, in particular axially between the first and second intermediate gears of the multi-stage transmission.

Preferably, the transmission input shaft is mounted in the transmission housing so as to be rotatable about an input shaft axis by first and second input shaft bearing means, and the transmission intermediate shaft is mounted in the transmission housing so as to be rotatable about an intermediate shaft axis by first and second intermediate shaft bearing means. According to an implementation, the second input shaft bearing may at least partially overlap axially with a toothing portion of the second drive gear. Furthermore, the second intermediate shaft bearing may be arranged axially adjacent to the second intermediate gear and may be completely axially offset relative to the second input shaft bearing. This design is particularly suitable for the embodiment in which the parking lock is arranged in the power path of the electric motor. In addition or alternatively, the first intermediate shaft bearing may also be completely axially offset from the first input shaft bearing. This design is particularly suitable for the embodiment in which the parking lock is arranged in the power path of the combustion engine.

The above-mentioned object is further solved by a hybrid drive comprising: an internal combustion engine; an electric machine; and a transmission assembly designed according to one or more of the above embodiments; wherein the input shaft of the multi-stage transmission is connected to the internal combustion engine, wherein the input shaft of the reduction gearing is connected to the electric machine, the hybrid drive further comprising a control unit for controlling the electric machine, the internal combustion engine, the shift clutch of the multi-stage transmission, and the clutch of the reduction gearing.

The hybrid drive assembly has the same advantages as the transmission assembly, so reference is made to the above description for brevity. All features described in connection with the transmission assembly can be implemented in the hybrid drive assembly.

The hybrid drive assembly can implement various operating modes. For example, in a first shift position of the transmission, torque is transmitted from the internal combustion engine to the drive axle with a first transmission ratio (first gear). In the second shift position, the multi-stage transmission transmits torque to the drive axle with a second transmission ratio (second gear). In the neutral position, respectively open position of the shift clutch, the power path between the internal combustion engine and the differential is interrupted. The electric machine can be variably controlled in both gears so that the two drive sources drive the drive axle together in superposition. It is also possible for the electric machine or the internal combustion engine alone to drive the differential gearing, respectively the drive axle. To do this, the clutch in the respective other power path must be opened.

The hybrid drive assembly may also comprise a generator connected to a generator input shaft of the transmission assembly, and an electrical storage device electrically connected to the generator for storing electrical energy. The generator is a second electric machine of the hybrid drive assembly. The generator can be permanently drivingly connected to the drive shaft of the combustion engine and, in neutral mode, run idle or, in generator mode, generate electrical current. The power of the electric motor can be less than the power of the combustion engine, and/or the power of the generator can be less than the power of the electric motor.

### BRIEF DESCRIPTION OF THE DRAWINGS

Certain embodiments are explained below with reference to the drawing figures. Herein:

FIG. 1 shows a transmission assembly, respectively hybrid drive assembly for a drive axle of a motor vehicle in a sectional view through the axes of rotation in a first embodiment, and

FIG. 2 shows a transmission assembly, respectively hybrid drive assembly for a drive axle of a motor vehicle in a sectional view through the axes of rotation in a second embodiment.

### DETAILED DESCRIPTION

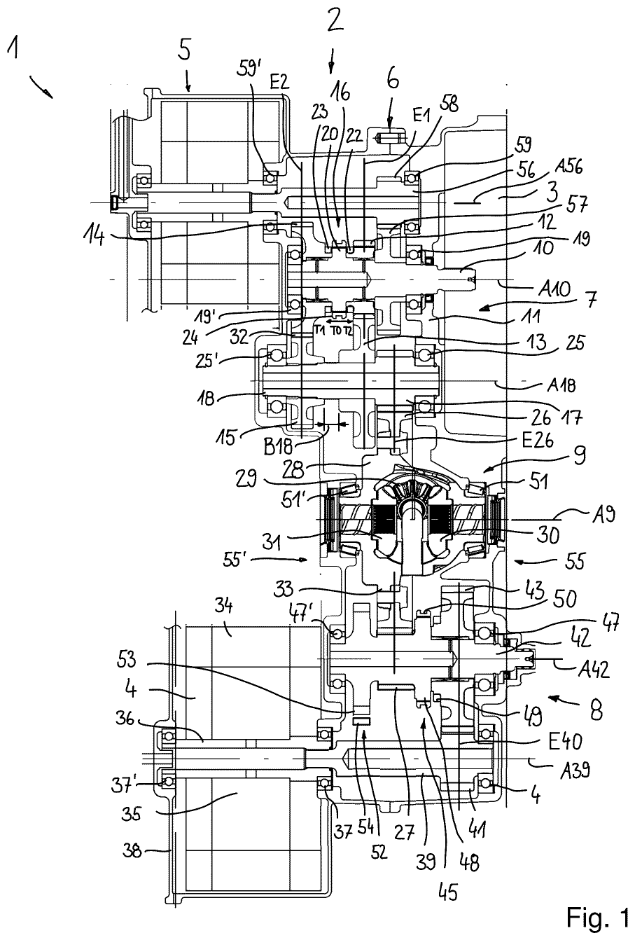

FIG. 1 shows a transmission assembly 2 for driving a vehicle axle, respectively a hybrid drive assembly 1. The hybrid drive assembly 1 comprises an internal combustion engine 3, an electric machine 4, an optional second electric machine in the form of a generator 5, and the transmission assembly 2.

The transmission assembly 2 is designed to transmit a first drive torque from the internal combustion engine 3 and/or a second drive torque from the electric machine 4 to a drive axle of the vehicle. For this purpose, the transmission assembly 2 has a transmission housing 6, a first gear unit in the form of a multi-stage transmission 7 associated with the internal combustion engine, a second gear unit in the form of a reduction gearing 8 associated with the electric motor, and a differential gearing 9, which is drivingly connected to the multi-stage transmission 7 and the reduction gearing 8.

The multi-stage transmission 7 enables transmission of power from the combustion engine to the differential gearing 9 with different transmission ratios or interruption of power transmission. A controllable shift clutch 16, which can also be referred to as a shift unit, is provided for shifting. The multi-stage transmission 7 has, in particular, an input shaft 10, which is mounted in the transmission housing 6 so as to be rotatable about an axis of rotation A10 and is drivingly connectable to the internal combustion engine 3, a first pair of gears 12, 13, which form a first gear plane E1, and a second pair of gears 14, 15, which form a second gear plane E2, and the controllable shift clutch 16. The shift clutch 16 is designed to selectively transmit rotational movement from the input shaft 10 via the first gears 12, 13 or the second gears 14, 15 to an output gear 17, or to interrupt the transmission of rotational movement. The output gear 17 is arranged axially outside a space formed between the first gear plane E1 and the second gear plane E2.

The first pair of gears comprises a first gear 12, which is rotatably mounted on the input shaft 10, and a first intermediate gear 13, which is connected in a rotationally fixed manner to an intermediate shaft 18 parallel to the input shaft 10. The second pair of gears comprises a second gear 14, which is rotatably mounted on the input shaft 10, and a second intermediate gear 15, which is connected to the intermediate shaft in a rotationally fixed manner. The first gear 12 is smaller than the second gear 14, and the first intermediate gear 13 is larger than the second intermediate gear 15. The shift clutch 16 is arranged axially between the first gear 12 and the second gears 14 which can also be referred to as drive gears. An axial distance B18 formed between the first intermediate gear 13 and the second intermediate gear 15 is smaller than an axial length L17 of the teeth of the output gear 17, in particular smaller than 0.8 times the axial length L17 of the teeth. The output gear 17 is arranged axially adjacent to the first intermediate gear 13, respectively axially between the latter and the side wall of the housing through which the input shaft 10 extends.

The input shaft 10 can be arranged coaxially with the motor shaft of the internal combustion engine and connected thereto in a permanently rotationally rigid or fixed manner. The input shaft 10 is mounted in the stationary housing 6 so as to be rotatable about the first axis of rotation A10 by first and second bearing means 19, 19′. Preferably, the second gear 14 is designed to be offset so that its toothing portion 32 has at least partial axial overlap with the second bearing means 19′ of the input shaft 10, which also applies accordingly to the toothed portion of the second intermediate gear 15.

The input shaft 10 may be provided with a longitudinal bore and several transverse bores for supplying lubricant to the bearing sections for the first gear 12 and the second gear 14. An input part 20 is provided axially between the first gear 12 and the second gear 14, which is firmly connected to the input shaft 10, in particular is integrally formed therewith.

The shift clutch 16 can be controlled by an actuator (not shown). Depending on the shift position (T0, T1, T2) of the shift clutch 16, several shift stages can be realized. A first shift stage is formed by the first pair of gears (12, 13) in order to transmit rotary motion with a low first transmission ratio i1 (first gear). A second shift stage is formed by the second pair of gears (14, 15) in order to transmit rotational movement with a higher second transmission ratio i2 (second gear). In a neutral position (T0), both gears 12, 14 are decoupled from the input part 20 and the input shaft 10, respectively.

In addition to the input part 20, the shift clutch 16 comprises a first output part 22 connected to the first gear 12 in a rotationally fixed manner, a second output part 23 connected to the second gear 14 in a rotationally fixed manner, and a coupling element 24 which can optionally couple the input part 20 to the first or second output part 12, 14 for transmitting torque. The coupling element 24 is designed in particular in the form of a sliding sleeve which is held on the input part 20 in a rotationally fixed manner and is axially displaceable relative thereto by the actuator. In a neutral position (T0), the sliding sleeve is freely rotatable relative to the first and second output parts 22, 23, and is connected in a rotationally fixed manner to the first output part 22 in the first switching position (T1) and to the second output part 23 in the second switching position (T2). The actuator can be designed, for example, as an electromotive, electromechanical, electromagnetic, hydraulic, or pneumatic actuator.

The two intermediate gears 13, 15 are connected to the intermediate shaft 18 in a rotationally fixed manner, in particular by an interference fit, i.e. press fit, wherein a connection by a form fit and/or a material bond is also possible. The intermediate shaft 18 is mounted in the housing 20 by bearing means 25, 25′ so as to be rotatable about the axis of rotation A18, which runs parallel to the axis of rotation A10 of the input shaft 10. The first intermediate shaft bearing 25 is arranged in the housing so that it is partially axially offset with respect to the first input shaft bearing 19. Furthermore, the second intermediate shaft bearing 25′ is arranged axially adjacent to the second intermediate gear 15 and completely axially offset relative to the second input shaft bearing 19′.

The intermediate shaft 18 is also arranged parallel to a rotational axis A8 of the reduction gearing 8 and/or a rotational axis A9 of the differential gearing 9. For power transmission, the output gear 17 of the multi-stage transmission 7 is in meshing engagement with the input gear 26 of the differential gearing 9. The input gear 26 of the differential, which is designed in particular in the form of a ring gear, is also in meshing engagement with the output gear 27 of the reduction gearing 8. In this way, drive power can be introduced into the differential from the multi-stage transmission and/or from the reduction gearing.

The output gear 17 of the multi-stage transmission 7 is arranged in particular on the side of the transmission assembly 2 facing the combustion engine, preferably axially between the first gear plane E1 and the side wall 11 of the housing 6, through which the input shaft 10 extends. Accordingly, the input gear 26 of the differential gearing 9, which meshes with the output gear 17, is also arranged axially adjacent to the pair of intermediate gears 13, 15.

The differential gearing 9 is designed to split a drive torque, respectively rotational movement initiated by the multi-stage transmission and/or reduction gearing and transmit it to the right and left side shafts of the vehicle axle. For this purpose, the differential gearing comprises a differential cage 28, several differential gears 29, which rotate jointly with the differential cage 28 around the axis of rotation A9, and two side shaft gears, which engage with the differential gears 28 and serve as output parts 30, 31 of the differential. The side shaft gears are to be connected via a respective side shaft (not shown) for transmitting torque. The differential cage 28 may have a flange section 33, wherein in this design the input gear 26 is arranged on the side of the flange facing the side wall 11 of the housing, on which the combustion engine is to be arranged.

A second power path is formed by the reduction gearing 8 in order to transmit drive torque via the input gear 26 to the differential cage 28. The reduction gearing 8 is to be drivingly connected to an electric machine 4. The electric machine 4 has, in particular, a stator 34 and a rotor 35 that is rotatable relative thereto, which rotor drives a motor shaft 36 when the machine is energized. The motor shaft 36 is mounted in a motor housing 38 so as to be rotatable about the axis of rotation A4 by bearing means 37, 37′. The rotational movement of the motor shaft 36 is transmitted to the input shaft 39 of the reduction gearing 8. The electric machine 4 is supplied with electrical current by a battery 36, wherein the battery can be charged by the electric machine 4 in generator mode. The electric machine 4 and/or the internal combustion engine 3 can be controlled by means of power electronics, such as a pulse inverter, with an integrated electronic control unit (ECU).

The reduction gearing 8 is designed to convert the rotational movement introduced by the electric machine 4 onto the input shaft 39 from high speed to low speed. The reduction gearing 8 has a first reduction stage with a drive gear 41 that is firmly connected to the input shaft 39, in particular designed as a single piece therewith, and an intermediate gear 43 that is designed as an idler gear mounted rotatably on an intermediate shaft 42. The drive gear 41 and the intermediate gear 43 are in meshing engagement with each other and form a first gear set with a first reduction ratio. The second reduction stage comprises the output gear 27 of the reduction gearing 8, which is firmly connected to the intermediate shaft 42, and the input gear 26 of the differential, which meshes therewith, forming a second gear set with a second reduction ratio.

The input shaft 39 is rotatably mounted in the housing 6 about the axis of rotation A39 by bearing means 46, 46′. The intermediate shaft 42 is rotatably mounted on a parallel axis of rotation A42 in the housing 6 by associated bearing means 47, 47′. A controllable clutch 45 is provided in the power path of the reduction gearing 8 in order to selectively transmit or interrupt a rotational movement.

The clutch 45 is designed in particular as a positive-locking clutch and can be transferred into a closed or open position by an actuator (not shown). The clutch 45 comprises a first clutch part 48, which is firmly connected to the intermediate shaft 42, in particular designed as a single piece, and a second clutch part 49, which is firmly connected to the intermediate gear 43, in particular designed as a single piece, as well as a coupling element 50. The coupling element 50 is designed in the form of a sliding sleeve which is held in a rotationally fixed manner on the first coupling part 48 and can is axially moveable relative thereto by the actuator. By form-fitting engagement of the coupling element 50 in the intermediate gear 43, the latter is connected in a rotationally fixed manner to the intermediate shaft, so that torque is transmitted from the electric motor to the differential.

The transmission assembly 2 comprises an optional parking lock unit 52. The parking lock unit 52 has a lock wheel 53, which is firmly connected to the intermediate shaft 42, and a schematically represented locking element 54, which is designed to engage with the lock wheel 53 to lock or release it. The lock wheel 53 is arranged axially between a plane spanned by the differential input gear 26 and a housing side 55′ to which the electric machine 4 is to be connected. The combustion engine 3 is arranged on the axially opposite side 55. The locking element 54 is directly connected to the differential input gear 26, which means that the differential is locked when the parking lock is engaged.

The transmission assembly 2 also has an optional generator shaft 56, which is rotatably mounted in the housing 6 via bearing means 59, 59′ on a rotational axis A56 parallel to the input shaft 10 of the multi-stage transmission. The generator shaft is connected to the input shaft 10 via a generator spur gear set. The generator 5 connected to the transmission housing can convert the drive power supplied by the combustion engine 3 into electrical energy, which can then be stored in a battery and later used for electric drive. The generator 5 is located on side 55′ of the transmission housing, which is opposite the combustion engine 3. Accordingly, the generator shaft 56 also extends out of the transmission housing on this side 55′. The generator spur gear set is located on the opposite side 55, specifically axially between the first gear plane E1 and the housing side wall 11 and/or approximately in the same plane as the toothing region of the differential input gear 26. The generator spur gear set comprises a gear 57 connected in a rotationally fixed manner to the input shaft 10 and a pinion 58 connected in a rotationally fixed manner to the generator shaft 56, which are in meshing engagement with each other. The gear 57 of the generator spur gear set has at least partial axial overlap with the output gear 17. This contributes to an axially compact design.

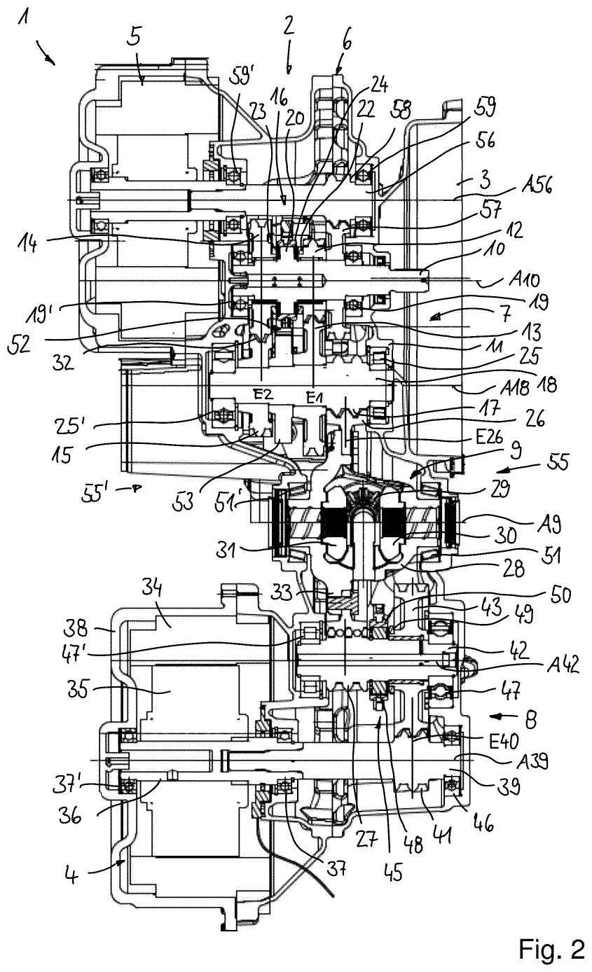

FIG. 2 shows a hybrid assembly 1 with a transmission assembly 2 in a further embodiment. In terms of structure and mode of operation, this corresponds largely to the embodiment shown in FIG. 1, so that reference is made to the above description with regard to the common features. Identical and/or corresponding details are assigned the same reference numbers as in FIG. 1.

A difference is the arrangement of the parking lock unit 52, which in the present embodiment is arranged on the intermediate shaft 18 of the multi-stage transmission and is connected thereto in a rotationally fixed manner. The lock wheel 53 is arranged axially between the first intermediate gear 13 and the second intermediate gear 15. The lock wheel 53 is in direct rotational connection with the differential in order to block it when the parking lock is closed.

A further difference is that the intermediate shaft 42 of the reduction gearing is shorter and the second bearing means 47′ are axially offset in relation to the second bearing means 51′ in the direction of a center plane of the differential.

The embodiments described have the advantage of a compact design in the axial direction.

Certain embodiments or components or features of components have been noted herein as being “preferred” and some options as being “preferable” or the like and such indications are to be understood as relating to a preference of the applicant at the time this application was filed. Such embodiments, components or features noted as being “preferred” or “preferable” or the like are optional and are not required for implementation of the innovations disclosed herein unless otherwise indicated as being required, or specifically included within the claims that follow.

1. A transmission assembly for a hybrid drive with an internal combustion engine and an electric motor, the transmission assembly comprising:
a transmission housing,
a multi-stage transmission with a transmission input shaft that is rotatably mounted in the transmission housing about an input shaft axis and drivingly connectable to the internal combustion engine, a first pair of gears which form a first gear plane (E1), and a second pair of gears which form a second gear plane, and a controllable shift clutch which is designed to selectively transmit rotational movement from the transmission input shaft via the first gears or the second gears to a transmission output gear, or to interrupt transmission of rotational movement,
a generator shaft arranged parallel to the transmission input shaft and drivingly connected thereto via a generator spur gear set, wherein the generator spur gear set at least partial overlaps axially with the transmission output gear,
a reduction gearing having an input shaft that is drivingly connectable to the electric machine and being designed to translate an input rotational movement to an output gear to slow speed; wherein a controllable clutch is provided in a power path of the reduction gearing to selectively transmit or interrupt the rotational movement;
a differential gearing with a differential input gear that meshes with the output gear of the multi-stage transmission and the output gear of the reduction gearing, as well as a first differential output member for driving a first side shaft and a second differential output member for driving a second side shaft,
wherein the output gear of the multi-stage transmission is axially located outside a space formed between the first gear plane and the second gear plane.

2. The transmission assembly according to claim 1,
wherein the reduction gearing comprises an intermediate shaft arranged parallel to the input shaft and drivingly connected thereto via spur gears,
wherein the controllable clutch is designed as a positive-locking clutch and is arranged on the intermediate shaft axially between one of the spur gears and the output gear of the reduction gearing.

3. The transmission assembly according to claim 1,
wherein the first pair of gears comprises a first gear rotatably mounted on the input shaft, and a first intermediate gear arranged on a transmission intermediate shaft parallel to the input shaft,
and the second pair of gears comprises a second gear rotatably mounted on the input shaft, and a second intermediate gear arranged on the transmission intermediate shaft,
wherein an axial distance between the first intermediate gear and the second intermediate gear is smaller than an axial length of the teeth of the output gear of the multi-stage transmission.

4. The transmission assembly according to claim 1,
wherein the first gear is smaller than the second gear, and
the first intermediate gear is larger than the second intermediate gear,
wherein the output gear of the multi-stage transmission is arranged axially between the first intermediate gear and a bearing of the intermediate shaft,
wherein the output gear of the multi-stage transmission is arranged axially between the first gear plane and a housing side wall through which the input shaft extends for connection to the internal combustion engine.

5. The transmission assembly according to claim 1,
wherein at least one of the first intermediate gear and the second intermediate gear is connected to the intermediate shaft by an interference fit.

6. The transmission assembly according to claim 1,
further comprising a parking lock unit having a lock wheel connected in a rotationally fixed manner to a rotatable component of the transmission assembly, and a locking element designed to engage with the lock wheel to selectively lock or release the lock wheel,
wherein the lock wheel is arranged axially between a differential input gear plane and a housing side wall to which the electric machine is connectable.

7. The transmission assembly according to claim 6,
wherein the lock wheel of the parking lock unit is arranged on the intermediate shaft of the reduction gearing axially between the housing side wall and the output gear of the reduction gearing.

8. The transmission assembly according to claim 6,
wherein the lock wheel of the parking lock unit is arranged axially on the intermediate shaft of the multi-stage transmission between the first intermediate gear and the second intermediate gear.

9. The transmission assembly according to claim 1,
wherein the input shaft of the multi-stage transmission is mounted in the transmission housing to be rotatable about an input shaft axis by a first and a second input shaft bearing, and
that the intermediate shaft of the multi-stage transmission is mounted in the transmission housing to be rotatable about an intermediate shaft axis by a first and a second intermediate shaft bearing,
wherein at least one of the first and second intermediate shaft bearings is arranged completely axially offset from one of the first and second input shaft bearings associated with a same housing side.

10. The transmission assembly according to claim 9,
wherein the second input shaft bearing at least partially overlaps axially with a toothing portion of the second gear, and
wherein the second intermediate bearing is arranged axially adjacent to the second intermediate gear and is axially offset relative to the second drive shaft bearing.

11. A hybrid drive arrangement comprising:
an internal combustion engine;
an electric machine;
a transmission assembly comprising
a transmission housing,
a multi-stage transmission with a transmission input shaft that is rotatably mounted in the transmission housing about an input shaft axis and drivingly connectable to the internal combustion engine, a first pair of gears which form a first gear plane, and a second pair of gears which form a second gear plane, and a controllable shift clutch which is designed to selectively transmit rotational movement from the transmission input shaft via the first gears or the second gears to a transmission output gear, or to interrupt transmission of rotational movement,
a generator shaft arranged parallel to the transmission input shaft and drivingly connected thereto via a generator spur gear set, wherein the generator spur gear set at least partial overlaps axially with the transmission output gear,
a reduction gearing having an input shaft that is drivingly connectable to the electric machine and being designed to translate an input rotational movement to an output gear to slow speed; wherein a controllable clutch is provided in a power path of the reduction gearing to selectively transmit or interrupt the rotational movement;
a differential gearing with a differential input gear that meshes with the output gear of the multi-stage transmission and the output gear of the reduction gearing, as well as a first differential output member for driving a first side shaft and a second differential output member for driving a second side shaft,
wherein the output gear of the multi-stage transmission is axially located outside a space formed between the first gear plane and the second gear plane wherein the input shaft of the multi-stage transmission is drivingly connected to the internal combustion engine, wherein the input shaft of the reduction gearing is drivingly connected to the electric machine,
a control unit for controlling the electric machine, the internal combustion engine, the shift clutch, and the clutch,
a generator that is drivingly connected to a generator shaft of the transmission assembly, and
an electrical storage device that is electrically connected to the generator for storing electrical energy.
